(19) United States
(12) Patent Application Publication
(10) Pub. No.: US 2003/0029289 A1
(43) Pub. Date: Feb. 13, 2003

(54) Paper corner trimmer

(76) Inventor: Chien-Fu Lin, Taichung City (TW)

Correspondence Address: Charles E. Baxley, Hart, Baxley, Daniels & Holton, Fifth Floor, 59 John St, New York, NY, 10038, US

(21) Appl. No.: 09/928,270

(22) Filed: Aug. 13, 2001

(51) Int. Cl. B26B 13/00

(52) U.S. Cl. 83/229; 83/234; 83/244

(57) ABSTRACT

A paper corner trimmer includes a first blade having an extension extending perpendicularly from a side thereof and a second blade is engaged with a shaft which extends through the extension. A torsion spring is mounted to the shaft and two legs of the spring respectively engage with the two blades. The second blade is slightly curved so that an angle is maintained between the two blades. Two positions on two ends of the cutting edge of the second blade are respectively stopped by two stop points on the first blade when the second blade is located at its two extreme positions.

### FIELD OF THE INVENTION

The present invention relates to a paper corner trimmer that includes a slightly curve upper blade and a lower blade which is pivotally connected to the upper blade by a shaft. The angle between the two blades is maintained to have an enough angle so as to smoothly trim the papers.

BACKGROUND OF THE INVENTION

A conventional paper corner trimmer is shown in FIG. 1 and generally includes a first blade 11 and a second blade 12 which is pivotally connected to the first blade 11 at two respective mediate portions of the two blades 11, 12. Each of the first blade 11 and the second blade 12 has a ring-shaped handle 10 so that the user separates the two handles 10 to let the two blades 11, 12 be pivoted away from each other. A sheet of paper is inserted between the two blades 11, 12 and cut by the respective edges of the blades 11, 12. An angle between the two blades 11, 12 becomes too small at the final step of cutting so that a large resistance exists and the user has to use a lot of effort to cut the paper. The space between the two blades 11, 12 is small and two blades 11, 12 move simultaneously so that the paper could be shifted and the position of cut is therefore changed.

SUMMARY OF THE INVENTION

In accordance with one aspect of the present invention, there is provided a paper corner trimmer which comprises a first blade having a first cutting edge defined in a first side thereof and an extension extends vertically from a second side of a first end of the first blade. A first hole is defined through the extension and a first notch is defined in a distal end of the extension. A first stop point is located on the first side of the first blade and close to the first end of the first blade.

A second blade has a second cutting edge defined in a first side thereof. A second notch is defined in the first side of the second blade and located close to the first end of the second blade. A second end of the second blade is bent relative to the first end of the second blade. A third notch is defined in the first side of the second blade and located close to the second end of the second blade. A portion of the first side close to the first end of the second blade contacts the first stop point. A portion of the first side close to the second end of the second blade contacts the second stop point.

A shaft has a torsion spring is mounted thereto and a first end of the shaft extends through the first hole in the extension. A slot is defined in a second end of the shaft and the first end of the second blade is engaged with the slot. A first leg of the torsion spring is engaged with the first notch in the extension and a mediate portion of a second leg of the torsion spring is engaged with the second notch. A distal end of the second leg of the torsion spring is engaged with the second side of the second blade.

The primary object of the present invention is to provide a paper corner trimmer that has a slightly curve blade so that a large angle is maintained between the two blades when cutting or trimming.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional paper corner trimmer;

FIG. 2 is an exploded view to show the paper corner trimmer of the present invention;

FIG. 3 is a top view to show the two blades of the trimmer of the present invention are trimming a corner of a sheet of a paper;

FIG. 4 is an illustrative view to show the trimmer of the present invention when the second blade is not pushed toward the first blade, and

FIG. 5 is an illustrative view to show the trimmer of the present invention when the second blade is pushed toward the first blade.

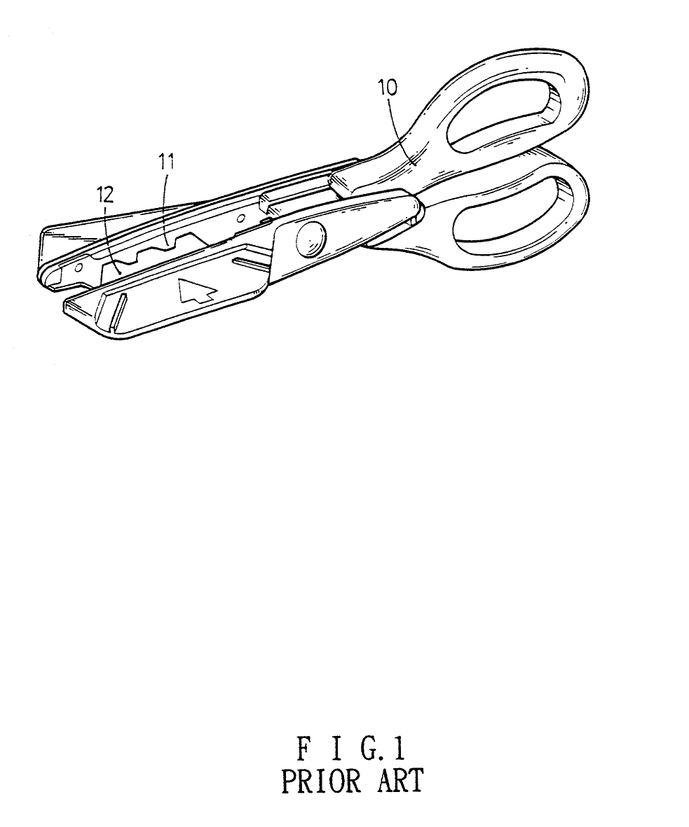

### DETAILED DESCRIPTION OF THE PREFERRED EMBODIMENT

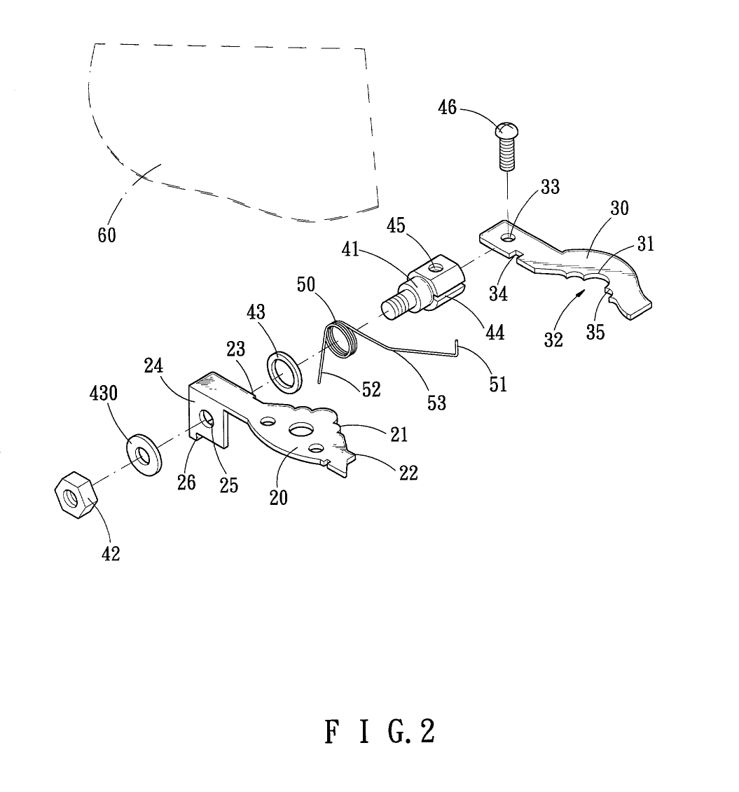

Referring to FIGS. 2 to 4, the paper corner trimmer of the present invention comprises a first blade 20 having a first cutting edge 21 defined in a first side thereof and an extension 24 extends vertically from a second side of a first end of the first blade 20. A first hole 25 is defined through the extension 24 and a first notch 26 is defined in a distal end of the extension 24. A first stop point 23 is located on the first side of the first blade 20 and close to the first end of the first blade 2. A second stop point 22 is located on the first side of the first blade 20 and close to a second end of the first blade 2.

A second blade 30 has a second cutting edge 31 defined in a first side thereof. A second notch 34 is defined in the first side of the second blade 30 and located close to the first end of the second blade 30. A second end 32 of the second blade 30 is bent relative to the first end of the second blade 30. In other words, the second blade 30 is slightly curved at the second end 32 thereof.

A shaft 41 has a torsion spring 50 and a washer 43 mounted thereto and a first end of the shaft 41 extends through the first hole 25 in the extension 24. A nut 42 and another washer 430 is threaded engaged with the first end of the shaft 41. A slot 44 is defined in a second end of the shaft 41 and the first end of the second blade 30 is engaged with the slot 44. A threaded hole 45 is defined in the second end of the shaft 41 and communicates with the slot 44. The second blade 30 has a second hole 33 defined through the first end thereof and a bolt 46 is engaged with the threaded hole 45 and extends through the second hole 33. A first leg 52 of the torsion spring 50 is engaged with the first notch 26 in the extension 24 and a mediate portion 53 of a second leg of the torsion spring 50 is engaged with the second notch 34. A distal end 51 of the second leg of the torsion spring 50 is engaged with the second side of the second blade 30.

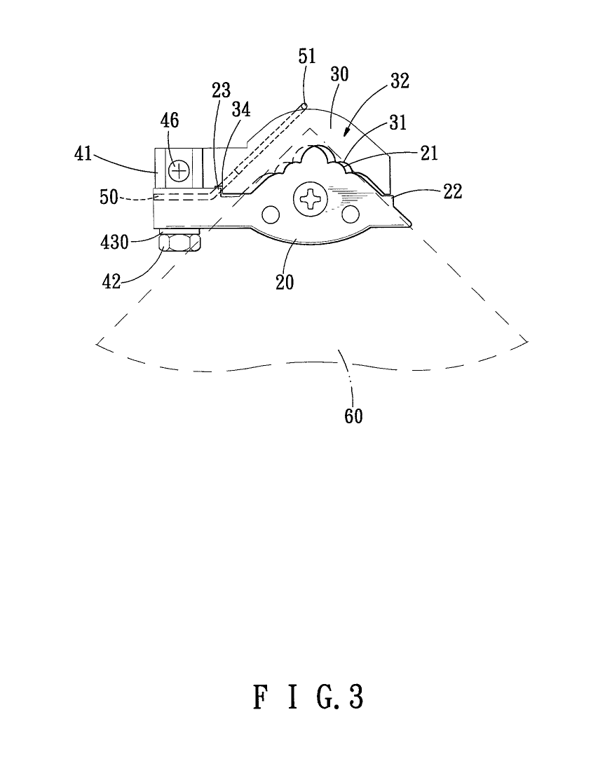

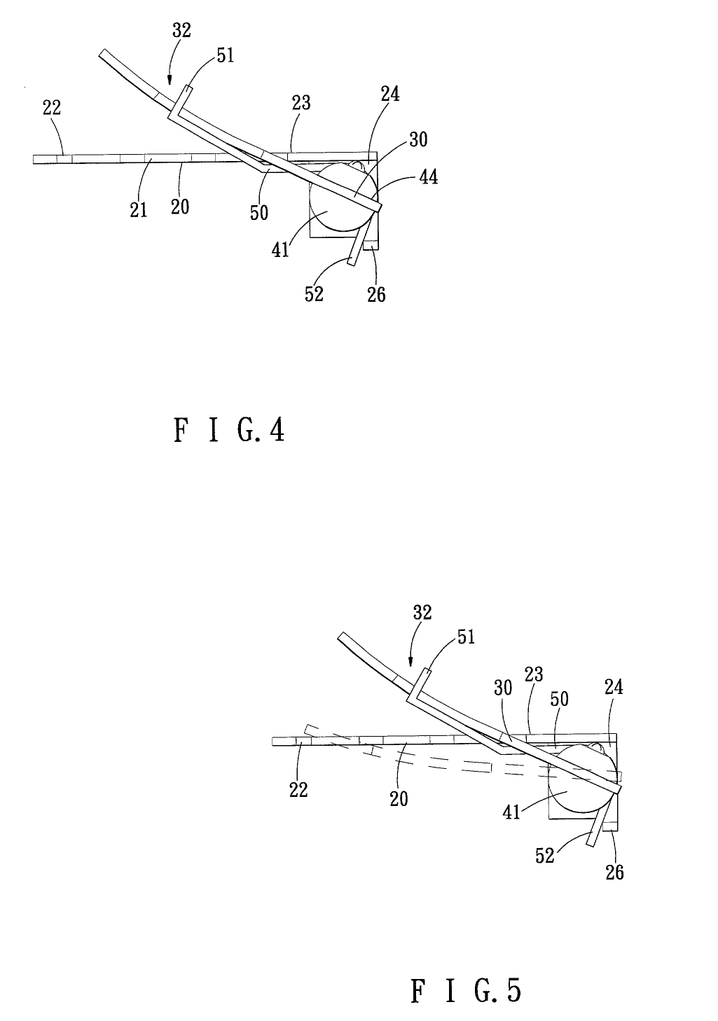

A portion of the first side close to the first end of the second blade 30 contacts the first stop point 23 when the second blade 30 is not yet pushed toward the first blade 20 as shown in FIG. 4. As shown in FIGS. 3 and 5, a sheet of paper 60 is put between the first blade 20 and the second blade 30, a corner of the sheet of paper is located at a position corresponding to the first cutting edge 21 and the second cutting edge 31. When pushing the second blade 30 toward the first blade 20, a portion of the first side close to the second end of the second blade 30 contacts the second stop point 22 so that the second blade 30 will not separate from the first blade 20 after the cutting or trimming action is finished.

While we have shown and described the embodiment in accordance with the present invention, it should be clear to those skilled in the art that further embodiments may be made without departing from the scope of the present invention.

What is claimed is:

1. A paper corner trimmer comprising:
a first blade having a first cutting edge defined in a first side thereof and an extension extending vertically from a second side of a first end of said first blade, a first hole defined through said extension and a first notch defined in a distal end of said extension, a first stop point located on said first side of said first blade and close to said first end of said first blade, a second stop point located on said first side of said first blade and close to a second end of said first blade;
a second blade having a second cutting edge defined in a first side thereof, a second notch defined in said first side of said second blade and located close to said first end of said second blade, a second end of said second blade bent relative to said first end of said second blade, a portion of said first side close to said first end of said second blade contacting said first stop point, a portion of said first side close to said second end of said second blade contacting said second stop point, and
a shaft having a torsion spring mounted thereto and a first end of said shaft extending through said first hole in said extension, a slot defined in a second end of said shaft and said first end of said second blade engaged with said slot, a first leg of said torsion spring engaged with said first notch in said extension and a mediate portion of a second leg of said torsion spring engaged with said second notch, a distal end of said second leg of said torsion spring engaged with said second side of said second blade.

2. The trimmer as claimed in claim 1 further comprising a threaded hole defined in said second end of said shaft and communicating with said slot, said second blade having a second hole defined through said first end thereof, a bolt engaged with said threaded hole and extending through said second hole.
